(19) United States
(12) Patent Application Publication
(10) Pub. No.: US 2026/0107960 A1
(43) Pub. Date: Apr. 23, 2026

(54) SOFT-COOKED EGGS

(71) Applicant: Michael Foods, Inc., Hopkins, MN (US)

(72) Inventors: Siquan LI, Hopkins, MN (US); Jonathan MERKLE, Hopkins, MN (US); Noel RUDIE, Hopkins, MN (US)

(21) Appl. No.: 19/360,766

(22) Filed: Oct. 16, 2025

Related U.S. Application Data
(60) Provisional application No. 63/708,615, filed on Oct. 17, 2024.

(51) Int. Cl. A23L 15/00; A23B 5/06; A23L 5/10

(52) U.S. Cl. CPC A23L 15/00; A23B 5/06; A23L 5/13

(57) ABSTRACT

The present disclosure relates to methods for mass producing a soft-cooked egg or soft-cooked egg food product. The soft-cooked eggs comprise a desired egg white texture, egg yolk texture, IgY content, and consumer acceptance.

### CROSS-REFERENCE TO RELATED APPLICATIONS

This application claims the benefit of priority U.S. Provisional Patent Application No. 63/708,615, filed Oct. 17, 2024, which is hereby incorporated by reference in its entirety.

### TECHNICAL FIELD AND BACKGROUND

### I. Technical Field

Aspects of this disclosure relate at least to methods for the preparation, physical treatment, and preservation of eggs.

### II. Background

Hard and soft-cooked eggs are consumed globally by many demographic groups and cultures. Hard-cooked eggs are characterized by egg whites that are cooked to a hard rubbery texture and yolks that are cooked to a solid and crumbly texture. Commercial processes to produce hard-cooked eggs are well established. Soft-cooked eggs are characterized by egg whites cooked to a tender, but fully cooked, texture, and the yolks having a texture ranging from a runny or slow cascade to a soft and spreadable paste, depending on consumer preferences. Soft-cooked eggs are exposed to lower cooking temperatures than hard-cooked eggs. For this reason, soft-cooked retain more non-denatured proteins than hard-cooked eggs and may be more nutritious than hard-cooked eggs.

Unlike hard-cooked eggs, soft-cooked eggs have been challenging to produce commercially. There are presently no methods or technologies for commercial bulk production of soft-cooked eggs that can balance the complex processing parameters (e.g., cook time and temperature) needed to yield finished products having the consistent textures and nutrition desired by consumers. As a result, soft-cooked eggs are generally cooked to order with increased product loss due to overcooking, which can result in a less nutritious product having an undesirable hardened and rubbery egg white texture, or undercooking, which can result in a product that is unsafe for human consumption due to the potential presence of pathogenic microorganisms such as Salmonella enteritidis and Listeria monocytogenes, of which the former is native in raw poultry products including eggs and can cause severe Salmonellosis and the latter is one of the major microbial risks of cooked egg products and can cause severe Listeriosis.

Thus, there is a need in the industry for commercial-scale processes for cooking soft-cooked eggs to a safe, reliable, and consistently desired texture while maximally retaining the nutritional value and health benefits of eggs.

### SUMMARY

This disclosure describes a solution to at least some of the problems associated with commercial-scale processes for bulk manufacture of soft-cooked eggs. The solution resides in the identification and implementation of optimal cooking conditions for yielding desired egg textures and nutrition that are achievable in a large production process. Several advantages can be realized when implementing the optimized processes disclosed herein. For example, in some aspects, the disclosed processes can ensure efficient production of products having a consistently desired texture and maximized nutritional value. This can lead to an increase in production throughput and reduced costs associated with reduced product losses due to inconsistencies or poor product quality. The end result is a faster, safer, and more profitable soft-cooked egg production process that provides a product having enhanced nutritional and sensory characteristics.

Accordingly, some aspects of the disclosure are directed to methods for bulk-producing soft-cooked eggs with non-denatured immunoglobulin Y (IgY). In some aspects, eggs used for methods of the disclosure comprise fresh eggs, nest run eggs, graded eggs, sized eggs, in-shell eggs, peeled eggs, aged eggs, tempered eggs, or a combination thereof. In certain aspects, a method comprises, consists of, or consists essentially of subjecting an egg to a precisely controlled temperature to produce a soft-cooked egg, comprising, consisting of, or consisting essentially of a concentration of non-denatured IgY between 35 mg to 150 mg per egg. In certain aspects, an egg is subjected to a precisely controlled temperature by liquid, steam, air, or a combination thereof. In certain aspects, liquid, steam, or air is heated to a temperature between 70° C. to 90° C. In certain aspects, an egg is subjected to a precisely controlled temperature for between 5 minutes to 20 minutes. In certain aspects, a yolk reaches a maximum temperature at or below 74.0° C. In certain aspects, a yolk reaches a maximum temperature between 60° C. to 74.0° C. In certain aspects, a method further comprises, consists of, or consists essentially of a step of cooling an egg to a temperature below 65° C. In certain aspects, about 25-100% of a total concentration of IgY of the egg is non-denatured compared to an average IgY concentration for fresh raw eggs. In certain aspects, a soft-cooked egg comprises, consists of, or consists essentially of an egg white having a tender texture. In certain aspects, a soft-cooked egg comprises, consists of, or consists essentially of a yolk having a runny, soft pasty, or creamy texture. In some aspects, the method comprises cooking between 2000-8000 in-shell eggs per hour.

In certain aspects, a method further comprises, consists of, or consists essentially of coating a soft-cooked egg with a protective material. In certain aspects, a protective material is a food grade material. In certain aspects, a protective material comprises, consists of, or consists essentially of Baker's glaze, food grade wax, white mineral oil, antimicrobial coatings, chitin-based coatings, or a combination thereof. In certain aspects, a protective material comprises, consists of, or consists essentially of Baker's glaze. In certain aspects, a soft-cooked egg has a shelf-life of greater than or equal to 60 days. In certain aspects, a soft-cooked egg coated with a protective material has a shelf-life of greater than or equal to 60 days.

Also disclosed herein is a soft-cooked egg or food product produced by any of the methods disclosed herein. In certain aspects, there is a soft-cooked egg with non-denatured IgY produced according to any of the methods disclosed herein. In certain aspects, there is a food product comprising, consisting of, or consisting essentially of any one of the soft-cooked eggs disclosed herein.

Also disclosed herein are methods for mass producing soft-cooked eggs with non-denatured IgY. In certain aspects, a method comprises, consists of, or consists essentially of: (a) mechanically conveying a plurality of eggs into a steam chamber; (b) incubating the plurality of eggs in the steam chamber; (c) mechanically conveying the plurality of eggs into a cook bath comprising a heated liquid; (d) incubating the plurality of eggs in the heated liquid; (e) cooling the plurality of eggs to a first temperature; (f) coating the plurality of eggs with a protective material; and (g) cooling the plurality of eggs to a second temperature, wherein the method produces a plurality of soft-cooked eggs. In some aspects, one or more of steps (a)-(g) are automated. In certain aspects, steam in the steam chamber is maintained at 70° C. to 90° C. In certain aspects, a heated liquid is maintained at 70° C. to 90° C. In certain aspects, a heated liquid comprises water, salt, vinegar, broth, stock, spices, seasoning, tea, or a combination thereof. In certain aspects, a spice comprises, consists of, or consists essentially of cinnamon, star anise, parsley, sage, rosemary ginger, chive, green onion, or a combination thereof. In certain aspects, a seasoning comprises, consists of, or consists essentially of salt, sugar, malt, soy sauce, mono-sodium glutamate, potassium glutamate, or a combination thereof. In certain aspects, a plurality of eggs are incubated inside a steam chamber and/or heated liquid for between 1 minute to 20 minutes. In certain aspects, a plurality of eggs are incubated inside a steam chamber for between 1 minute to 20 minutes. In certain aspects, a plurality of eggs are incubated inside a heated liquid for 1 minute to 20 minutes. In certain aspects, a plurality of eggs are cooled at step (e) in cooled cooking bath liquid, at room temperature, or inside a cooling chamber. In certain aspects, a first temperature is less than or equal to 65° C. In certain aspects, second temperature is less than or equal to 25° C. In certain aspects, each egg is mechanically deposited into an egg allocator prior to step (a). In certain aspects, each egg is secured in the egg allocator after being deposited into the egg allocator. In certain aspects, a protective material comprises a food grade material. In certain aspects, a protective food-grade material comprises Baker's glaze, food-grade wax, white mineral oil, antimicrobial coatings, chitin-based coatings, or a combination thereof. In certain aspects, a protective material comprises Baker's glaze. In certain aspects, a plurality of soft-cooked eggs comprise a cooked egg white having a tender texture and/or a cooked yolk having a runny, soft pasty, or creamy texture. In certain aspects, a the plurality of eggs comprise, fresh eggs, nest run eggs, graded eggs, sized eggs, in-shell eggs, peeled eggs, aged eggs, tempered eggs, pasteurized eggs, or a combination thereof. In certain aspects, a plurality of soft-cooked eggs comprises 2000-8000 soft-cooked eggs per hour.

Also disclosed herein is a plurality of soft-cooked eggs with non-denatured IgY produced according to any of the methods disclosed herein. In certain aspects, a plurality of soft-cooked eggs have a shelf-life greater than or equal to 60 days.

Also disclosed herein is a plurality of soft-cooked eggs, comprising, consisting of, or consisting essentially of a cooked egg white having a tender texture and a cooked yolk having a runny, soft pasty, or creamy texture, the cooked egg yolk comprising, consisting of, or consisting essentially of 25-100% of non-denatured IgY relative to total IgY content of the egg. In certain aspects, a plurality of soft-cooked eggs comprise, consist of, or consist essentially of cooked eggs white having a tender texture and a cooked yolk having a runny, soft pasty, or creamy texture, the cooked egg yolk comprising, consisting of, or consisting essentially of about 35 mg to 150 mg of non-denatured IgY per egg yolk. In certain aspects, a plurality of soft-cooked egg comprise, consist of, or consist essentially of a cooked egg yolk comprising, consisting of, or consisting essentially of about 35 mg to 150 mg of non-denatured IgY per egg yolk.

As used herein, the term “egg” refers to a shelled egg (also referred to as “in-shell egg”), that is, an egg having an egg yolk and albumen inside an uncracked shell.

As used herein, the term “cook” or “cooking” refers to a process of preparing a food item by applying heat. Cooking may be achieved by baking, simmering, boiling, stewing, grilling, steaming, and/or frying. Cooking may involve the transformation of the physical state of a starting product, such as changes in the state of matter (e.g., solid, liquid, gas); changes in texture (e.g., softening, hardening, gelatinization, etc.); change in size and/or shape (e.g., expansion, contraction, etc.); and/or, changes in protein denaturation and/or coagulation (e.g., solidification of egg white and/or egg yolk). As used herein, the term “cooked” refers to an item that has undergone a cooking process.

As used herein, the term “tender” refers to texture that is soft and delicate, yet firm enough to hold its shape. A tender egg white is smooth, easy to cut or bite into, moist, and not dry. A tender egg-white does not have a rubbery or tough texture.

As used herein, the term “runny” refers to a liquid texture. A runny egg-yolk is fluid and flows easily when the egg, e.g., a cooked egg, is cut open. A runny egg yolk is typically bright yellow or orange and has a glossy appearance. A runny egg yolk is cooked to a sufficient temperature to ensure that the yolk is substantially free of pathogens, e.g., Salmonella enteritidis or Listeria monocytogenes, while limiting the gelling of yolk proteins to maintain a slightly thickened but fluid state.

As used herein, the term “slow-cascading” refers to a viscous texture. A slow-cascading yolk is cooked enough to be thickened while retaining a fluid state. A slow-cascading yolk flows noticeably slower, in comparison to a runny yolk, when an egg, e.g., a cooked egg, is cut open.

As used herein, the term “spreadable” refers to a soft, creamy, and buttery texture. A spreadable yolk has a smooth, creamy texture allowing it to be spread with a utensil, such as a butter knife or spoon. A spreadable yolk retains enough moisture to be pliable, but cannot flow by itself, as would a runny or slow-cascading yolk. A spreadable yolk is cooked enough to thicken while retaining a soft, spreadable texture.

As used herein, the term “pasty” refers to a texture that is thick, does not flow, does not spread easily, and holds its shape. A pasty yolk is denser and firmer than a spreadable yolk; it is soft and jammy, providing little to no resistance when chewing. A pasty yolk is typically yellow and has a matte appearance.

As used herein, the term “overcooked egg yolk” refers to a cooked egg yolk having a solidified, dry, crumbly, and chalky texture. An overcooked egg yolk may develop a greenish or graying ring on the outer surface due to a chemical reaction between iron in the yolk and sulfur in the albumen.

As used herein, the term “overcooked egg white” refers to a cooked egg white having a rubbery, tough, dense, and dry texture.

As used herein, an “overcooked egg” refers to a cooked egg having an overcooked egg white, overcooked egg yolk, or both.

As used herein, the term “soft-cooked egg” refers to a cooked egg with a tender egg white and runny or slow-cascading to soft, spreadable, or pasty yolk.

As used herein, the term “hard-cooked egg” refers to a cooked egg with very firm, even rubbery, egg white and a fully solid, even crumbly, yolk. A hard cooked-egg is less dry and hard than an overcooked egg. A typical cooking condition to produce a hard-cooked egg is cooking the egg in water at a temperature between 206-212° F. (96.7-100° C.) for 20 minutes or fully boiling for 12-15 min.

As used herein, the term “shelf-life” refers to the amount of time that an egg retains its quality (e.g., texture and flavor) and remains suitable for human consumption, e.g., devoid or substantially devoid of microbes that cause disease. For example, an egg may become rotten after its stated shelf-life, or become rotten before its shelf-life if stored improperly. A shelf-life of a soft-cooked egg prepared according to the methods disclosed herein can be, e.g., 1, 2, 3, 4, 5, 6, or 7 or more days, weeks, or months.

As used herein, the term “food product” refers to a processed, e.g., cooked, seasoned, packaged, stored, or distributed, food or food derivative (e.g., egg or egg-derivative). For example, a soft-cooked egg may be considered a food product.

The claims are not intended to include, and should not be interpreted to include, means plus- or step-plus-function limitations, unless such a limitation is explicitly recited in a given claim using the phrase(s) “means for” or “step for,” respectively.

The use of the term “or” in the claims is used to mean “and/or” unless explicitly indicated to refer to alternatives only or the alternative are mutually exclusive, although the disclosure supports a definition that refers to only alternatives and “and/or.” The phrase “and/or” means “and” or “or”. To illustrate, A, B, and/or C includes: A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, the compositions and methods of the present disclosure that “comprise,” “have,” “include” or “contain” one or more elements possesses those one or more elements, but are not limited to possessing only those one or more elements. Likewise, an element of a composition or method of the present disclosure that “comprises,” “has,” “includes” or “contains” one or more features possesses those one or more features, but is not limited to possessing only those one or more features.

Any embodiment of the compositions and methods of the present disclosure can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Compositions and methods “consisting essentially of” any of the elements or steps disclosed limits the scope of the claim to the specified materials or steps which do not materially affect the basic and novel characteristic of the claimed disclosure. The words “consisting of” (and any form of consisting of, such as “consist of” and “consists of”) means including, and limited to, whatever follows the phrase “consisting of.” Thus, the phrase “consisting of” indicates that the listed elements are required or mandatory, and that no other elements may be present.

As used herein, in the specification, “a” or “an” may mean one or more, unless clearly indicated otherwise. As used herein, in the claim(s), when used in conjunction with the word “comprising,” the words “a” or “an” may mean one or more than one. As used herein “another” may mean at least a second or more.

In any disclosed aspect, the terms “about” and “approximately” and “substantially” and the like may be substituted with “within [a percentage] of” what is specified. In one non-limiting aspect, the percentage includes 0.1, 0.5, 1, 5, and 10 percent.

A composition disclosed herein may be considered “substantially free” of a substance when the amount of the substance is not sufficient to materially affect the structural, functional, or chemical properties of the composition. For example, a food product, such as soft-cooked eggs, may be substantially free of pathogens if the quantity of pathogens detected meets local regulatory standards, such as USDA standards. Additionally, or alternatively, a composition disclosed herein may be considered “substantially free” of a substance when the concentration of the substance in the composition is less than 0.1 wt. %.

As used herein, unless the surrounding text explicitly indicates a contrary intention, all values given in the form of percentages are weight per weight (w w), weight percent, or wt. %, corresponding to the proportion of a particular substance within a mixture, as measured by weight or mass.

As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

Unless defined otherwise, all technical and scientific terms used herein have the same meanings as commonly understood by one of ordinary skill in the art to which this technology belongs. Although any methods and materials similar or equivalent to those described herein can be used in the practice or testing of the present technology, the preferred methods, devices and materials are now described. All technical and patent publications cited herein are incorporated herein by reference in their entirety.

It is specifically contemplated that any limitation discussed with respect to one embodiment of the invention may apply to any other embodiment of the invention. Furthermore, any composition of the invention may be used in any method of the invention, and any method of the invention may be used to produce or to utilize any composition of the invention. Any embodiment discussed with respect to one aspect of the disclosure applies to other aspects of the disclosure as well and vice versa. For example, any step in a method described herein can apply to any other method. Moreover, any method described herein may have an exclusion of any step or combination of steps. Aspects of an embodiment set forth in the Examples are also embodiments that may be implemented in the context of embodiments discussed elsewhere in a different Example or elsewhere in the application, such as in the Summary, Detailed Description, Claims, and Brief Description of the Drawings.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

Various features and advantageous details are explained more fully with reference to the non-limiting aspects illustrated in the accompanying drawings and detailed in the following description. It should be understood, however, that the detailed description and the specific examples, while indicating aspects of the disclosure, are given by way of illustration only, and not by way of limitation. Various substitutions, modifications, additions, and/or rearrangements will become apparent to those of ordinary skill in the art from this disclosure.

FIG. 1 is a diagram outlining illustrative method steps employed in the production of soft-cooked eggs as disclosed herein.

FIG. 2 shows a correlation between cooking temperature, cooking time, and cooked egg white textures. FIG. 2A shows a surface plot comparing scoring of egg white firmness (“white firmness”) by a panel of consumers to egg cooking time (minutes) and cooking temperature (° C.). FIG. 2B shows scoring of egg white acceptability (“white acceptance”) by a panel of consumers compared to the egg cooking time (minutes) and cooking temperature (° C.), where egg white acceptability corresponds to the consumers' preferred egg white texture.

FIG. 3 shows a correlation between cooking temperature, cooking time, and cooked egg yolk textures. FIG. 3A shows a surface plot comparing scoring of egg yolk firmness (“yolk firmness”) by a panel of consumers to cooking time (minutes) and cooking temperature (° C.). FIG. 3B shows scoring of egg yolk acceptability (“yolk acceptance”) by a panel of consumers compared to egg cooking time (minutes) and cooking temperature (° C.), where egg yolk acceptability corresponds to the consumers' preferred egg yolk texture.

FIG. 4 shows a correlation between cooking temperature, cooking time, and cooked egg textures. FIG. 4A shows a surface plot comparing scoring of overall egg acceptability (“overall acceptance”) by a panel of consumers to cooking time (minutes) and cooking temperature (° C.), where overall egg acceptability corresponds to the consumers' preferred egg white and egg yolk textures. FIG. 4B shows a contour plot comparing scoring of overall egg acceptability (“overall acceptance”) by a panel of consumers compared to egg cooking time (minutes) and cooking temperature (° C.), where overall egg acceptability corresponds to the consumers' preferred egg white and egg yolk textures.

FIG. 5 shows representative images of soft-cooked eggs produced using methods disclosed herein.

### DETAILED DESCRIPTION

In general, the present disclosure relates to a soft-cooked egg, soft-cooked egg food product, and processes to prepare a soft-cooked egg or soft-cooked egg food product. In some aspects, methods for commercial or bulk production of soft-cooked eggs or soft-cooked egg food products are disclosed. The disclosed methods can yield faster, safer, and more profitable soft-cooked eggs having better texture and nutrition than hard-cooked eggs or soft-cooked eggs produced by other methods.

### I. Eggs

Eggs are used in a variety of food ingredients and products, including the soft-cooked eggs and soft-cooked egg products disclosed herein. Eggs for production of soft-cooked eggs traditionally have been in the form of whole (shell) eggs. The soft-cooked eggs according to the present disclosure may comprise eggs from different sources, sizes, and quality.

For example, an egg may be a fresh egg, that is, an egg that is within 1, 2, 3, 4, 5, 6, or 7 days of laying, is edible and is suitable for human consumption. An egg may be a nest run egg, that is, an egg without further processing (e.g., washing, grading, or sizing) after being laid.

An egg may be a graded egg, that is, an egg that has undergone a grading process, such as the egg grading process used by the United States Department of Agriculture (USDA). An egg may be grade AA, grade A, grade B, as established by the USDA.

An egg may be a sized egg, that is an egg that has been categorized based on its size, such as its weight. For example, an egg may be sized based on USDA standards, which size eggs based on minimum net weight per dozen, including jumbo (minimum 30 ounces net weight per dozen), extra-large (minimum 27 ounces net weight per dozen), large (minimum 24 ounces net weight per dozen), medium (minimum 21 ounces net weight per dozen), small (minimum 18 ounces net weight per dozen), or peewee (minimum 15 ounces net weight per dozen). In some aspects, a sized egg may be graded in accordance with USDA grading standards. In some aspects, a sized egg may not be graded in accordance with USDA standards.

An egg may be an aged egg, that has been incubated under desired conditions, such as temperature and humidity, to achieve a desired air cell size and peeling quality after cooking. An egg may be a tempered egg, that is an egg brought to a desired temperature prior to further processing, such as cooking. Tempering an egg can minimize stress, such as damages to the shell, from rapid changes in temperature, such as when placing an egg in a heated cooking chamber or cooking bath. Tempering an egg can also improve cooking methods by helping maintain a stabler and more consistent temperature in the cooking chamber and throughout the egg. Tempering an egg requires caution and limiting the tempering time to minimize or prevent microbial growth. A tempered egg may be brought to a temperature at least, at most, exactly, or between any two of 7, 10, 13, 16, 19, 22, and 25° C.

Egg white, also known as albumen, is the clear, alkaline liquid portion of the egg surrounding the egg yolk. Egg white constitutes roughly two-thirds of a chicken egg by weight. Egg white includes 10-12% (w/w) protein as well as trace amounts of minerals, fats, vitamins, and carbohydrates carried in water. Slightly more than half of the protein content of eggs is contained in the egg white.

Egg yolk is a complex oil-in-water emulsion that includes about 50% water, 30-35% lipids and 15-20% protein, including immunoglobulins such as IgY. Chickens produce IgY in response to antigen stimulation and can transfer IgY to the egg yolk during egg development. A typical large egg contains about 35-150 mg of IgY in about 15 mL of liquid yolk, depending on the hens' breed and prior exposure to pathogens, such as Salmonella. For example, Amro et al. (2018) reported that IgY concentration in yolk varies from breed to breed, from 3.66 mg/mL for Single Comb White Leghorns egg yolk to 8.37 mg/mL for Rhode Island Red. Greater exposure to the pathogens will induce a greater production of IgY and a higher IgY concentration in the yolk. Thus, immunization of hens can boost IgY production, resulting in eggs with higher concentrations of IgY.

IgYs are a group of immunoglobulins present in egg yolk that can provide health benefits to consumers, such as passive protection against pathogens. Eggs of the disclosure, which contain non-denatured IgY, could provide public health benefits by helping to prevent or minimize infection. Oral ingestion of IgY can prevent the development of or minimize the severity of foodborne diseases, including bacterial and viral illnesses, or may provide benefits to consumers, such as passive immunization against enteric pathogens. In some aspects, consumption of IgY reduces the probability of developing a disease caused by a foodborne pathogen, such as enterotoxigenic E. coli, Campylobacter jejuni, Shigella spp., Listeria, Salmonella, Astrovirus, Norovirus, and Rotavirus. In some aspects, consumption of egg with non-denatured IgY can act as a prophylactic against foodborne diseases.

As one example, Listeriosis is a foodborne disease caused by the bacteria Listeria monocytogenes. Severe symptoms of Listeriosis include fever, vomiting, trouble breathing, crying and disinterest in eating in newborn babies, fever, chills, upset stomach, diarrhea, nausea, vomiting, muscle aches, confusion, loss of balance, and convulsion. Severe Listeriosis may cause sepsis, meningitis, or encephalitis. Unlike many other pathogens, in pregnant women Listeriosis can cause infections in the developing fetus and can lead to premature labor, delivery of low-birth-weight infants, or even still birth. Listeriosis during pregnancy may affect the child later in life, contributing to intellectual disability, seizures, blindness, or developmental disorders of the brain, heart, or kidney. Avoiding potential risks of Listeriosis during pregnancy is important for the healthy development of the fetus.

Beyond the public health benefits, IgY content in an egg may also provide strong financial and commercial benefits to a manufacturer by incentivizing consumers looking for increased health benefits to buy eggs or egg products ready for consumption that contain non-denatured IgY.

In some aspects, the soft-cooked eggs disclosed herein are cooked at a temperature and for a time suitable to preserve protein in the egg yolk, egg white, or egg yolk and egg white, i.e., to reduce or prevent protein denaturation. In some aspects, the soft-cooked eggs disclosed herein are cooked at a temperature and for a time suitable to preserve immunoglobulins in the egg yolk, egg white, or egg yolk and egg white, i.e., to reduce or prevent immunoglobulin denaturation. In some aspects, the soft-cooked eggs disclosed herein are cooked at a temperature and for a time suitable to preserve IgY in the egg yolk, egg white, or egg yolk and egg white, i.e., to reduce or prevent IgY denaturation. In some aspects, the soft-cooked eggs disclosed herein are cooked at a temperature and for a time suitable to preserve 35 mg or more of non-denatured IgY per egg yolk.

In some aspects, soft-cooked eggs disclosed herein are cooked at a temperature and for a time suitable for cooking the egg yolk and egg white to a desired texture. In some aspects, soft-cooked eggs disclosed herein are cooked at a temperature and for a time suitable for cooking the egg white to a tender texture and the egg yolk to a runny or slow-cascading to soft, spreadable, or pasty texture.

### II. Methods for Producing Eggs

The soft-cooked eggs of the disclosure may be processed, or cooked, for a time and at a temperature sufficient for production of soft-cooked eggs or soft-cooked egg products having appropriate textures and nutritional values. For example, the time and temperature may be precisely controlled to ensure that eggs are fully cooked and sterilized (e.g., pasteurized), with a tender egg white and a runny, cascading, or pasty yolk, and with reduced protein denaturation compared to hard-cooked eggs or overcooked soft-cooked eggs.

A system for cooking the soft-cooked eggs can include, e.g., a steam chamber, a chamber with a cooking bath, or a steam chamber with a cooking bath. The system can further include a temperature monitoring system comprising multiple resistant temperature detector (RTD) sensors and a programmable logical controller (PLC) to regulate and modulate the temperature of the cooking chamber, cooking bath, steam, or a combination thereof. In some aspects, the precision of the temperature control by the system is within 0.5° C. (e.g., at least, at most, exactly, or between any two of ±0.1, 0.2, 0.3, 0.4, or 0.5° C.). In some aspects, the precision of the temperature control by the system is within 0.2° C. (e.g., at least, at most, exactly, or between any two of 0.01, 0.025, 0.05, 0.075, 0.1, 0.125, 0.15, 0.175, or 0.2° C.). In some aspects, the system can raise the temperature at a rate of about 1-2° C. per minute. In some aspects, the system can raise the temperature at a rate of about 5° C. per minute. In some aspects, precise temperature control can produce consistent egg white and egg yolk textures. In some aspects, precise temperature control can also reduce or prevent some proteins (e.g., immunoglobulin Y, or IgY) from denaturing. In some aspects, precise temperature control facilitates commercial-scale or bulk production of soft-cooked eggs having a desired texture and/or protein (e.g., IgY) content.

In some aspects, a method of the disclosure produces pasteurized eggs. For example, a method of producing soft-cooked eggs of the disclosure may require incubating the eggs at a temperature and time sufficient for cooking that also results in pasteurization. In some aspects, soft cooked eggs of the disclosure comprise non-denatured IgY and are pasteurized.

In some aspects, an egg can be cooked by maintaining the egg at 70-90° C. (e.g., at least, at most, exactly, or between any two of 70, 71, 72, 73, 74, 75, 76, 77, 78, 79, 80, 81, 82, 83, 84, 85, 86, 87, 88, 89, or 90° C.) for a specified amount of time. An egg can be cooked by maintaining the egg at 70-90° C. An egg can be cooked by maintaining the egg at 72-74° C. for a specified amount of time. An egg can be cooked by maintaining the egg at 77-79° C. for a specified amount of time. An egg can be cooked by maintaining the egg at 80-84° C. for a specified amount of time. An egg can be cooked by maintaining the egg at 81-83° C. for a specified amount of time. An egg can be cooked by maintaining the egg at about 90° C. for a specified amount of time.

The length of time at which the egg is maintained at a specified temperature or temperature range for cooking depends on the particular temperature(s) employed for cooking but generally ranges from at least, at most, exactly, or between any two of 5 to 20 minutes (e.g., at least, at most, exactly, or between any two of 5, 6, 7, 8, 9, 10, 11, 12, 13, 14, 15, 16, 17, 18, 19, or 20 minutes). In some aspects, an egg can be cooked by maintaining the egg at 70-90° C. for 5 to 20 minutes. In some aspects, an egg can be cooked by maintaining the egg at 72-74° C. for 10 to 18 minutes. In some aspects, an egg can be cooked by maintaining the egg at 77-79° C. for of 11 to 13 minutes. In some aspects, an egg can be cooked by maintaining the egg at 80-84° C. for 6 to 10 minutes. In some aspects, an egg can be cooked by maintaining the egg at 81-83° C. for 7 to 9 minutes. In some aspects, an egg can be cooked by maintaining the egg at 90° C. for about 14 minutes.

An egg can be cooked in such a way that non-denatured protein (e.g., immunoglobulins like IgY) is preserved (i.e., protein denaturation is reduced or prevented). In some aspects, cooking an egg to preserve non-denatured protein (e.g., immunoglobulins like IgY) is accomplished by maintaining the egg at 70-90° C. An egg can be cooked in such a way to preserve non-denatured IgY by maintaining the egg at 72-74° C. for a specified amount of time. An egg can be cooked in such a way to preserve non-denatured protein (e.g., immunoglobulins like IgY) by maintaining the egg at 77-79° C. for a specified amount of time. An egg can be cooked in such a way to preserve non-denatured protein (e.g., immunoglobulins like IgY) by maintaining the egg at 80-84° C. for a specified amount of time. An egg can be cooked in such a way to preserve non-denatured protein (e.g., immunoglobulins like IgY) by maintaining the egg at 81-83° C. for a specified amount of time. An egg can be cooked in such a way to preserve non-denatured protein (e.g., immunoglobulins like IgY) by maintaining the egg at 90° C. for a specified amount of time.

The length of time at which the egg is maintained at a specified temperature or temperature range for cooking in such a way to preserve non-denatured protein (e.g., immunoglobulins like IgY) depends on the particular temperature(s) employed for cooking but generally ranges from at least, at most, exactly, or between any two of 5 to 20 minutes (e.g., at least, at most, exactly, or between any two of 5, 6, 7, 8, 9, 10, 11, 12, 13, 14, 15, 16, 17, 18, 19, or 20 minutes).

In some aspects, an egg can be cooked in such a way to preserve non-denatured protein (i.e., to reduce or prevent denaturation of proteins, e.g., immunoglobulins like IgY) by maintaining the egg at 70-90° C. for 5 to 20 minutes. In some aspects, an egg can be cooked in such a way to preserve non-denatured protein (e.g., immunoglobulins like IgY) by maintaining the egg at 72-74° C. for 10 to 18 minutes. In some aspects, an egg can be cooked in such a way to preserve non-denatured protein (e.g., immunoglobulins like IgY) by maintaining the egg at 77-79° C. for 11 to 13 minutes. In some aspects, an egg can be cooked in such a way to preserve non-denatured protein (e.g., immunoglobulins like IgY) by maintaining the egg at 80-84° C. for 6 to 10 minutes. In some aspects, an egg can be cooked in such a way to preserve non-denatured protein (e.g., immunoglobulins like IgY) by maintaining the egg at 81-83° C. for 7 to 9 minutes. In some aspects, an egg can be cooked in such a way to preserve non-denatured protein (e.g., immunoglobulins like IgY) by maintaining the egg at about 90° C. for at about 14 minutes.

In some aspects, the egg, whether pasteurized or unpasteurized, or cooked or uncooked, may be cooled to about or below 65° C., e.g., cooled to at least, at most, exactly, or between any two of 65° C., 60° C., 55° C., 50° C., 45° C., 40° C., 35° C., 30° C., 25° C., 20° C., 15° C., 10° C., 5° C., 0° C. In some aspects, the egg, whether pasteurized or unpasteurized, or cooked or uncooked, may be cooled to about or below 25° C. In some aspects, the egg, whether pasteurized or unpasteurized, or cooked or uncooked, may be cooled to about or below 8° C. In some aspects, the egg, whether pasteurized or unpasteurized, or cooked or uncooked, may be cooled to or below 4° C. In some aspects, soft-cooked eggs are not cooled below 0° C. because undesirable changes may result to the texture of the cooked egg white and/or yolk. In some aspects, soft-cooked eggs are cooled to at least, at most, exactly, or between any two of 20, 21, 22, 23, 24, 25, 26, 27, 28, 29, 30, 31, 32, 33, 34, 35, 36, 37, 38, 39, or 40° C. during packaging and before storage. In some aspects, soft-cooked eggs are cooled to at least, at most, exactly, or between any two of 4, 5, 6, 7, 8, 9, 10, 11, 12, 13, 14, 15, 16, 17, 18, 19, or 20° C. after packaging and during storage. In some aspects, 20-40° C. can advantageously prevent condensation from developing inside the package.

Soft-cooked eggs may be cooled after cooking to a specific temperature to achieve a desired texture. For example, in one aspect, a chilling tower in which the soft-cooked eggs travel vertically at a desired velocity may be used to cool the soft-cooked eggs. In some aspects, soft-cooked eggs are cooled at room temperature or using chilled air. Additionally, or alternatively, soft-cooked eggs may be cooled by methods such as, but not limited to, use of a refrigerator, air conditioner, ice, dry ice, liquid nitrogen, cooling fans, fans, evaporative cooling, water, cooled water, mist, etc.

The methods of preparing soft-cooked eggs disclosed herein may include one or more cooling steps. For example, a method of preparing the soft-cooked eggs of the disclosure may include a first cooling step in which the soft-cooked eggs may be quickly cooled to less than or equal to 65° C. (e.g., cooled to a temperature of at least, at most, exactly, or between any two of 65° C., 60° C., 55° C., 50° C., 45° C., 40° C., 35° C., or 30° C.) after exiting a cooking chamber to stop the cooking reaction. The soft-cooked eggs may be cooled at a first cooling step at a rate of 5-10° C./min or 2-5° C./min. The soft-cooked eggs may be cooled at a second cooling step to less than or equal to 25° C. (e.g., cooled to a temperature of at least, at most, exactly, or between any two of 25° C., 20° C., 15° C., 10° C., or 5° C.) after application of a protective shell-coating material, such as Baker's glaze. The soft-cooked eggs may be cooled at a second cooling step at a rate of 5-10° C./min or 2-5° C./min.

An egg may lose the outer cuticle of the egg shell during the washing and cooking process. This outer cuticle protects against pathogens and loss of moisture. A soft-cooked egg may therefore be coated with a food-grade protective material to, e.g., increase its shelf-life. Examples of suitable protective materials include Baker's glaze, food-grade wax, white mineral oil, antimicrobial coatings, chitin-based coatings, or a combination thereof. An example of Baker's glaze includes shellac glaze in alcohol, mono-glyceride, di-glyceride, and food grade titanium dioxide. A coating, such as Baker's glaze, can provide protection against post-processing microbial invasion of the egg shell and a glossy shell appearance.

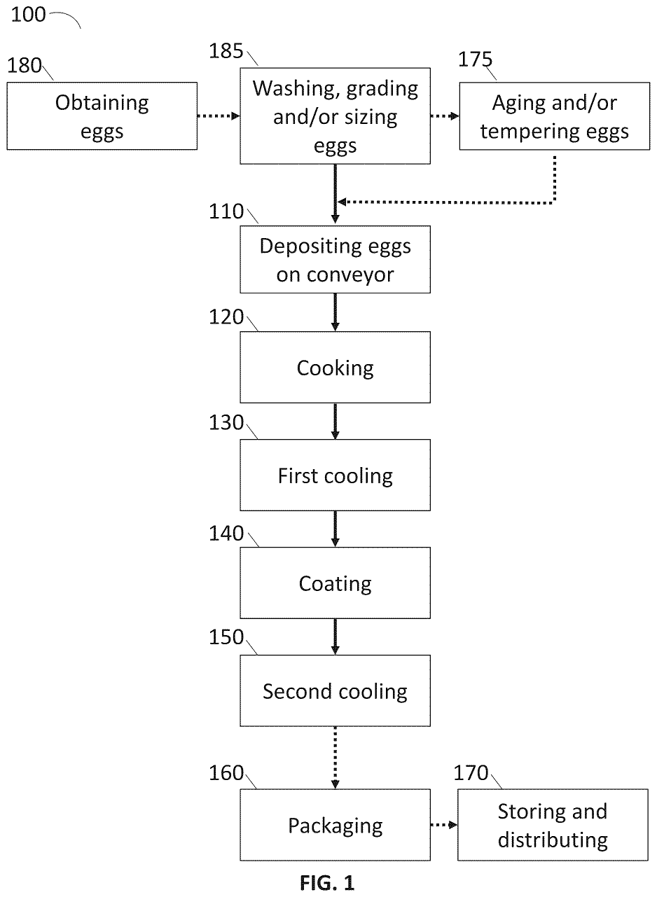

Reference is now made to FIG. 1, which is a simplified flowchart 100 of a method for producing soft-cooked eggs, in accordance with aspects of the present disclosure.

At first step 185, eggs washed, sized, and/or graded. Eggs may be sized or graded according to USDA standards as jumbo, extra-large, large, medium, small, or peewee. Eggs used for methods of the disclosure may be jumbo, extra-large, large, medium, small, or peewee. In some aspects, eggs used for methods of the disclosure may be large. Eggs may be washed with warm water e.g., at least 32.2° C. Warm water can prevent the egg from contracting and drawing polluted water inside the shell. Eggs may be washed with a detergent or detergent sanitizer. As part of the washing process, eggs may be rinsed with a chemical sanitizer to remove bacteria. At step, 110, eggs are deposited on a conveyor. The conveyor can mechanically and automatically deposit each of the eggs into an egg holder that holds each egg in such a way that most of the egg's surface is exposed. The egg holders also keep the eggs from touching each other and leave sufficient space between eggs during the cooking process to promote equal and consistent exposure of each egg to the cooking temperature.

At step 120, the eggs are cooked inside a pre-heated cooking chamber. The chamber may comprise a cooking medium, such as steam or water, heated to a specified temperature. The eggs are conveyed into the chamber by the egg holders at a constant speed, thereby exposing the eggs to the cooking medium. The velocity of the conveyor is adjusted depending on the length of the cooking chamber or cooking bath, the time that the eggs will spend cooking, and the temperature of the cooking medium. The eggs remain inside the chamber for a specified amount of time sufficient to achieve soft-cooked eggs of desired texture and/or non-denatured protein (e.g., IgY) content. The time for which the eggs are held in the cooking chamber begins when the eggs enters the chamber and ends when the eggs exit the chamber. In some aspects, the cooking medium inside the chamber is heated to 70-90° C., e.g., to at least, at most, exactly, or between any two of 70, 71, 72, 73, 74, 75, 76, 77, 78, 79, 80, 81, 82, 83, 84, 85, 86, 87, 88, 89, or 90° C., or to 72-74° C., 77-79° C., 80-84° C., 81-83° C., or 90° C. In some aspects, the eggs remains in the cooking chamber and/or cooking medium for 5-20 minutes, e.g., at least, at most, exactly, or between any two of 5, 6, 7, 8, 9, 10, 11, 12, 13, 14, 15, 16, 17, 18, 19, or 20 minutes, or 10-18 minutes, 11 to 13 minutes, 6 to 10 minutes, 7 to 9 minutes, or 14 minutes. In some aspects, the cooking medium inside the chamber is heated to 70-90° C., and the eggs remain in the cooking chamber for 5 to 20 minutes. In some aspects, the cooking medium inside the chamber is heated to 72-74° C., and the eggs remain in the cooking chamber for 10 to 18 minutes. In some aspects, the cooking medium inside the chamber is heated to 77-79° C., and the eggs remain in the cooking chamber for 11 to 13 minutes. In some aspects, the cooking medium inside the chamber is heated to 80-84° C., and the eggs remain in the cooking chamber for 6 to 10 minutes. In some aspects, the cooking medium inside the chamber is heated to 81-83° C., and the eggs remain in the cooking chamber for 7 to 9 minutes. In some aspects, the cooking medium inside the chamber is heated to 90° C., and the eggs remain in the cooking chamber for 14 minutes. After the eggs have been incubated at step 120 in the cooking chamber and/or cooking medium under continuous conveying for the specified amount of time, the eggs are considered to be cooked, and the cooked eggs exit the cooking chamber. In some aspects, a machine for bulk production of soft-cooked eggs of the disclosure can produce at least, at most, exactly, or between any two of 500, 1500, 2000, 2500, 3000, 3500, 4000, 4500, 5000, 5500, 6000, 6500, 7000, 7500, 8000, 8500, 9000, 9500, 10000 soft-cooked eggs per hour.

At step 130, the cooked eggs exit the cooking chamber for a first cooling step. First cooling step 130 may be achieved by any suitable means known in the art. For example, in some aspects, cooked eggs can be conveyed by the egg holders through a cooling tower in which room temperature or chilled air is used to actively cool the cooked eggs. In other aspects, cooked eggs may be passively cooled at room temperature as they travel on the conveyor. In some aspects, cooked eggs are cooled with a sanitized water shower or with sanitized water spray as they travel on the conveyor. In some aspects, cooked eggs are cooled to a first temperature that is at or below about 65° C., e.g., at most, exactly, or less than 65° C., 60° C., 55° C., 50° C., 45° C., 40° C., 35° C., or 30° C. Cooling can stop the cooking process, thereby preventing the eggs from overcooking once they leave the cooking chamber. After first cooling step 130, the eggs are considered to be soft-cooked.

At step 140, the soft-cooked eggs are coated with a protective material. The protective material can be automatically applied onto the shell of the soft-cooked eggs by conveying the soft-cooked eggs through a spraying or dripping station, for example. Alternatively, the protective material may be manually applied. A protective material for coating soft-cooked eggs can be a food-grade protective material, such as Baker's glaze, food-grade wax, white mineral oil, antimicrobial coatings, chitin-based coatings, or a combination thereof. In some aspects, the protective material can reduce contamination of the eggs, thereby extending shelf-life.

At step 150, the soft-cooked eggs are subjected to a second cooling step. Second cooling step 150 may be achieved by any suitable means known in the art. For example, the soft-cooked eggs can be conveyed by the egg holders through a cooling tower in which chilled air cools the soft-cooked eggs. Additionally, or alternatively, soft-cooked eggs may be conveyed into a refrigerator for second cooling step 150. In some aspects, the soft-cooked eggs are cooled at second cooling step 150 to a temperature that is between about 0° C. and about 33° C., e.g., at most, exactly, or less than 33° C., 30° C., 25° C., 20° C., 15° C., 10° C., 5° C. or 0° C. In some aspects, the soft-cooked eggs are cooled at second cooling step 150 to a temperature that is at or below about 8° C. In some aspects, the soft-cooked eggs are cooled at second cooling step 150 to a temperature that is at or below about 4° C. In some aspects, the soft-cooked eggs are cooled at second cooling step 150 to a temperature that is at about 0° C. In some aspects, the soft-cooked eggs are cooled at second cooling step 150 to a temperature that is at or below about 30° C. In some aspects, second cooling step 150 can promote drying of the protective coat. In some aspects, second cooling step 150 can help extend the shelf-life of the soft-cooked eggs.

In some aspects, method 100 may further comprise one or more additional steps, represented by dashed lines in FIG. 1. For example, method 100 may further comprise one or more of optional steps 160, 170, 175, or 180.

At step 160, soft-cooked eggs are packaged. The soft-cooked eggs may be first packaged in clam shells, cartons, flats, or a combination thereof. The first packaged soft-cooked eggs may be second packaged in master cases. Packaged, soft-cooked eggs may be distributed to buyers and/or consumers.

At step 170, the packaged soft-cooked eggs may be stored and distributed. Packaged, soft-cooked eggs may be stored in a refrigerator. Packaged, soft-cooked eggs may be stored at a temperature that is at or below about 8° C. Packaged, soft-cooked eggs may be stored at a temperature that is at or below about 4° C.

In some aspects, the eggs used to produce the soft-cooked eggs are fresh nest run eggs, graded eggs, sized eggs, in-shell eggs, peeled eggs, aged eggs, tempered eggs, or a combination thereof. At step 180, eggs are acquired. The eggs obtained at step 180 can be washed, sized, and/or graded at step 185 and deposited on the conveyor at step 110.

In some aspects, eggs are aged or tempered at stage 175 prior to step 110. In some aspects, eggs are tempered to 7-25° C. by storing eggs in a tempering room prior to processing, e.g., to at least, at most, exactly, or between any two of 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35° C. Eggs may be tempered by incubating in a heated medium, such as warm air. In some aspects, the eggs are tempered for 60-180 minutes, e.g., at least, at most, exactly, or between any two of 60, 65, 70, 75, 80, 85, 90, 95, 100, 105, 110, 115, 120, 125, 130, 135, 140, 145, 150, 155, 160, 165, 170, 175, and 180 minutes. Tempering the eggs can improve cooking consistency by reducing the changes in temperature in the cooking chamber when the eggs enter the chamber.

### EXAMPLES

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1—Conditions for Producing Soft-Cooked Eggs

To identify cooking conditions for producing soft-cooked eggs, large eggs (ranging from 56-63 grams; average of 60 grams per egg) large eggs were used for testing the effect of different temperature and cooking time combinations on texture and approval or acceptance of the resulting texture by a panel of consumers.

Firmness (e.g., “texture”) and acceptance of the cooked egg or egg components were evaluated by the consumer panel. Panelists chewed soft-cooked egg samples and rated the firmness of the egg white and egg yolk of the soft-cooked egg, and their acceptance of the egg white and egg yolk texture on a 10-point hedonic scale. In terms of firmness, 10 represented a very firm or rubbery texture similar to the texture of a hard-cooked egg, while 1 represented a liquid, soft mousse texture. In terms of acceptance, 10 represented the ideal texture for a soft-cooked egg desired by the tester, while 1 represented the least ideal texture desired by the tester.

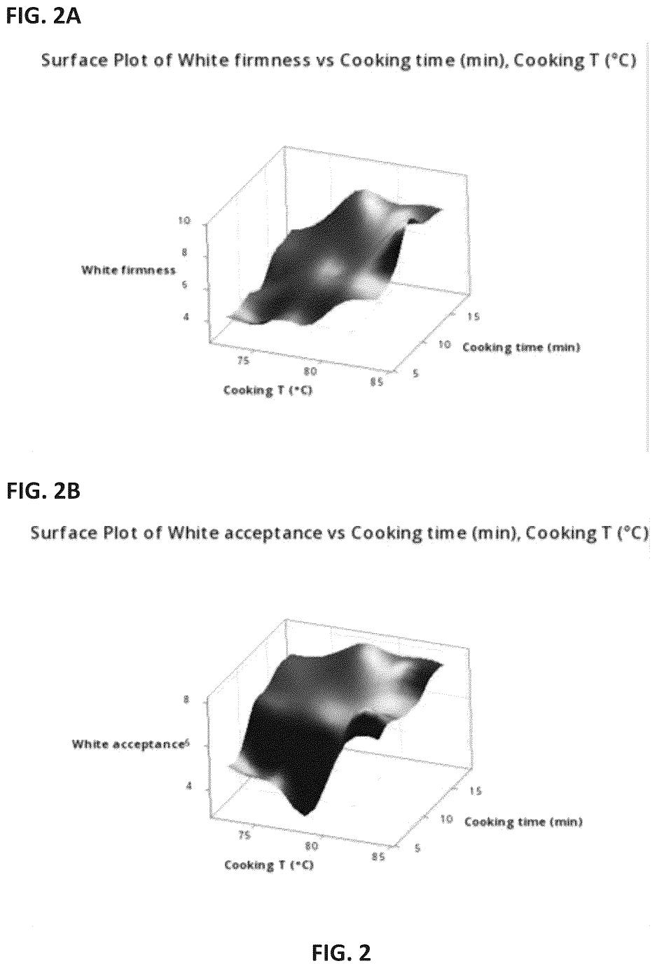

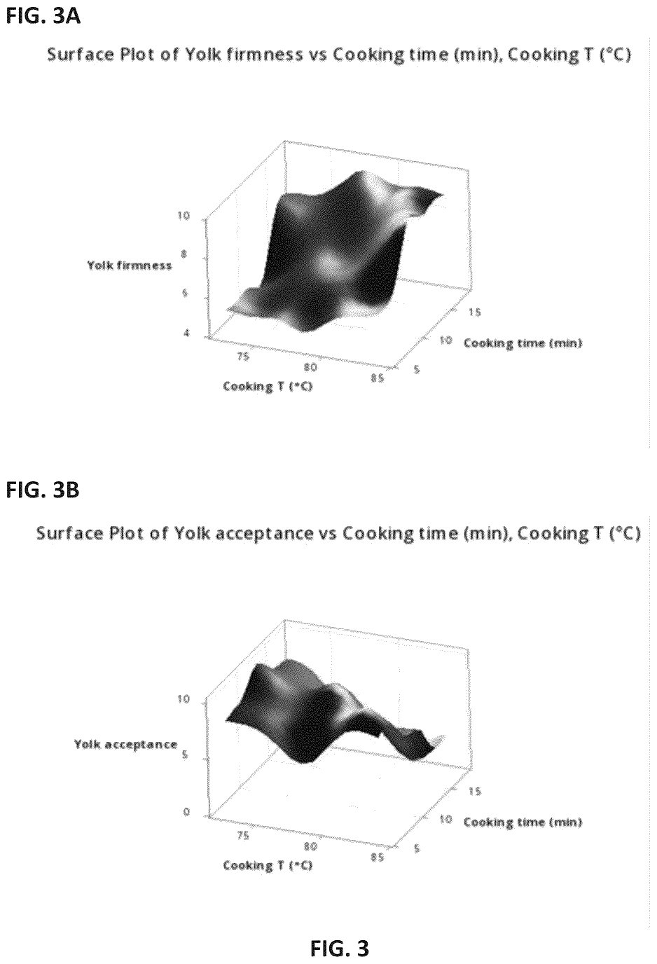

It was found that, as temperature or cooking time increased, firmness also increased (FIGS. 2-3). Acceptance, however, did not exhibit a linear or direct relationship and appeared to be affected by both temperature and time in unique, non-predictable ways. For example, while egg white acceptance exhibited a greater score at higher cooking times and temperatures, egg yolk acceptance exhibited greater acceptance at mid-to-lower cooking times and at higher temperatures (FIGS. 2-3).

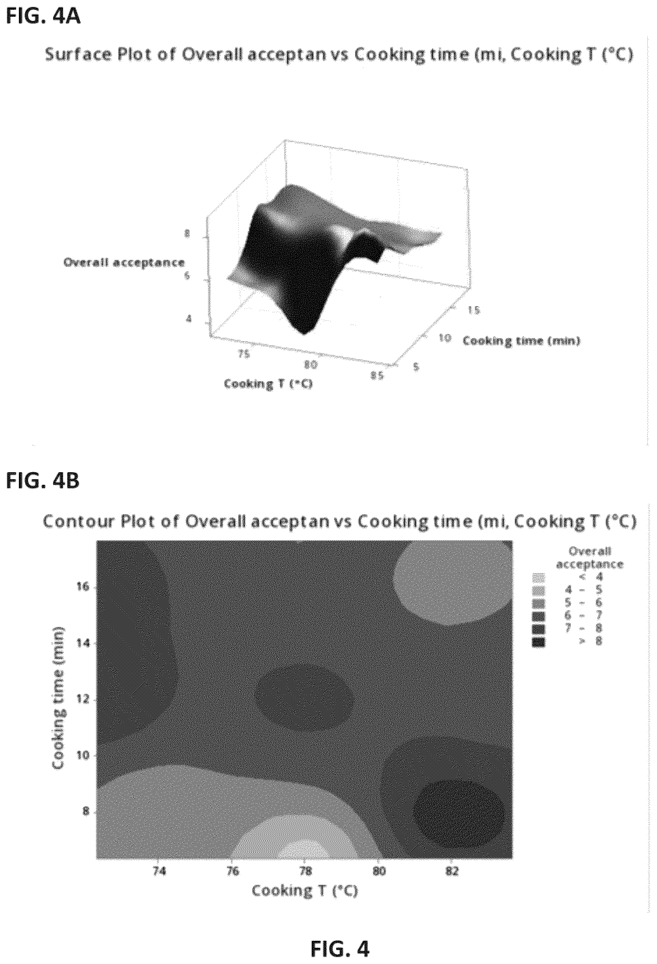

Overall acceptance of the soft-cooked eggs was also influenced by both time and temperature in non-predictable ways (FIG. 4). Contour plot analysis revealed that the highest rates of overall acceptance clustered at three discrete cooking time and temperature combinations: 1) about 72-74° C. for about 10-18 minutes, 2) about 77-79° C. for about 11-13 minutes, and 3) about 80-84° C. for about 6-10 minutes. The highest acceptance scores clustered at about 81-83° C. for about 7-9 minutes (FIG. 4B).

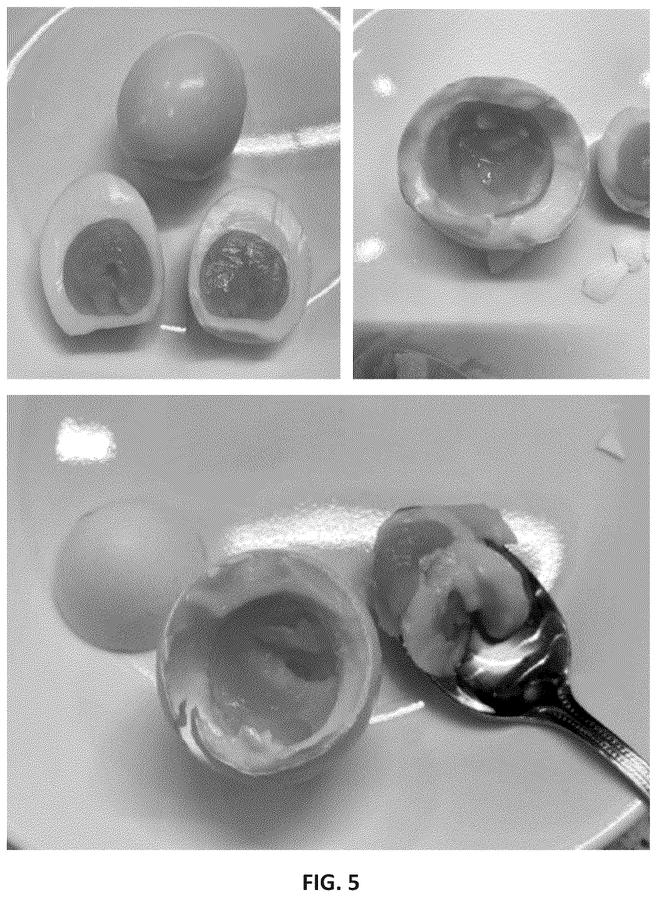

Eggs cooked using these identified parameters consistently yielded soft-cooked eggs of excellent texture suitable for a commercial food product (FIG. 5). These eggs exhibited a soft, pasty looking yolk and a tender looking egg white (FIG. 5).

### Example 2—Bulk Production of Soft-Cooked Eggs

For commercial purposes, soft-cooked eggs are produced in large batches according to the parameters identified by the inventors to consistently produce soft-cooked eggs of excellent texture and/or desired IgY content.

Fresh nest run eggs are acquired, washed, sized and/or candled to remove any eggs unsuitable for a commercial product and/or human consumption. Retained eggs are sized into different groups by weight, such as jumbo, extra-large, large, medium, small, and peewee, per USDA grading guidelines. Eggs requiring aging are aged on pallets.

Eggs ready for processing are loaded onto a conveyor belt that automatically transfers eggs to individual egg holders. Each holder has 3-4 thin plastic fingers that hold the egg in place during the automatic cooking process. The holders transport each egg into a closed steam chamber, which can also contain a cooking water bath. The cooking timer begins as soon as the eggs enter the chamber. The eggs are incubated 3-13 minutes in contact with steam at a controlled temperature of 70-90° C. At the end of the steam exposure, the eggs travel down and are submerged into a cooking water bath at a consistent temperature of 70-90° C. (+/−0.5° C.) for 3-13 minutes. In total, the eggs will have cooked for between about 5-20 minutes in steam and/or cooking water. To ensure proper cooking time, the eggs travel uniformly across the steam and/or cooking water chamber at a precisely controlled velocity to precisely control the dwell time inside the cooking chamber and bath. The velocity at which the eggs travel across the cooking chamber or medium will depend on the desired cooking time at a specific temperature and the dimensions of the cooking chamber. After the desired cooking time is achieved, the eggs automatically exit the cooking chamber.

Once the eggs are sufficiently cooked, the eggs are automatically released from the holders onto a wired belt conveyor where the eggs cool at room temperature. Sufficiently cooled eggs are coated with Baker's glaze and transported to a cooling tower for further cooling at room temperature air or using chilled air.

Eggs are packaged in clam shells, cartons, or flats, packed into master cases, labeled, palletized, and stored in a refrigerated warehouse until ready for transportation to a distribution center for commercial distribution.

The steam chamber and water baths are allowed to reach temperature equilibrium after a warm up period at the beginning of each shift run and between batches.

### Example 3—IgY Denaturation in Soft-Cooked Eggs

The inventors also investigated the effects of the egg cooking methods described in Examples 1 and 2 on IgY denaturation.

The total IgY content in the yolk of eggs from 4 different group conditions was assessed. Pasteurized eggs were incubated in hot water at a temperature of 128-138° F. (53.3-58.9° C.) for 54-60 minutes. Soft-cooked eggs were cooked at 90° C. for 14 minutes in hot water. Hard-cooked eggs were cooked at 96.7-100° C. for 20 minutes in hot water. All eggs were store-purchased fresh shell eggs washed at 32.2-46.1° C. with food-grade detergents.

The amount of non-denatured IgY in each egg type was determined using a commercially-available ELISA kit (ABNOVA™, Total IgY ELISA Kit) and by scanning the ELISA wells at a wavelength of 450 nm. The ELISA kit used for this example uses anti-IgY antibodies that detect non-denatured IgY. Thus, lower levels of IgY detection represent higher IgY denaturation. Values were normalized to the amount of non-denatured IgY found in fresh nest run eggs and is represented as “percent survival (%)”. The non-denatured IgY content of each of the four egg types is shown in Table 1.

TABLE 1
IgY Content

| Group | IgY Content (mg/g of yolk) | Percent Survival |
|---|---|---|
| Fresh nest run eggs | 8.29 ± 1.06 | 100.00% |
| In-shell pasteurized eggs | 9.83 ± 1.27 | 118.58% |
| Soft-cooked eggs | 2.34 ± 0.56 | 28.23% |
| Hard-cooked eggs | Not detectable | —.— |

The results showed that the maximum temperature and time disclosed for cooking soft-cooked eggs achieved a higher preservation of non-denatured protein (e.g., IgY) compared to hard-cooked eggs. As shown in Table 1, the IgY in hard-cooked eggs was undetectable, indicating complete denaturation, whereas more than 28% of IgY remained detectable (non-denatured) in the soft-cooked eggs. The results also suggested that the disclosed soft-cooked eggs and methods to prepare same preserve IgY in amounts that could provide health benefits to consumers by providing passive immunity and protection against pathogenic microorganisms and viruses, while hard-cooked eggs would not. A higher amount of non-denatured IgY in soft-cooked eggs can provide passive immunological protection to consumers against pathogens of concerns, such as Salmonella, E. coli, Listeria, Mycobacterium tuberculosis and viruses such as norovirus and SARS-CoV-2 (COVID-19).

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The references cited herein, to the extent that they provide exemplary procedural or other details supplementary to those set forth herein, are specifically incorporated herein by reference.
1. Sudjarwo S A, Eraiko K, Sudjarwo G W and Koerniasari. 2017. The potency of chicken yolk immunoglobulin (IgY) specific as immunotherapy to Mycobacterium tuberculosis infection. J. Adv. Pharm. Tech. Research. 8 (3): 91-96.
2. Pereira E P V, Tilburg M F V, Florean E O P T and Duedes M I F. 2019. Egg yolk antibodies (IgY) and their applications in human and veterinary health: A review. International Immunopharmacology. 73 (2019): 293-303.
3. Amro W A, Al-Qaisi W and Ai-Razem F. 2018. Production and purification of IgY antibodies from chicken egg yolk. Journal of Genetic Engineering and Biotechnology. 16 (2018): 99-103.
4. Wei S, Duan S, Liu X, Wang H, Ding S, Chen Y, Xie J, Tian J, Yu N, Ge P, Zhang X, Chen X, Li Y and Meng Q. 2021. Chicken egg yolk antibodies (IgYs) block the binding of multiple SARS0CoV-2 spike protein variants to human ACE2. International Immunopharmacology. 90 (2021): 107172.

1. A method of bulk-producing soft-cooked eggs, the method comprising cooking eggs at 70 to 90° C. for 5 to 20 minutes to produce the soft-cooked eggs, wherein the soft-cooked eggs comprise 35 mg to 150 mg of non-denatured IgY.

2. The method of claim 1, wherein bulk production comprises cooking between 2000-8000 in-shell eggs per hour.

3. The method of claim 1, wherein about 25-100% of a total concentration of IgY of the soft-cooked eggs is non-denatured compared to an average IgY concentration for fresh raw eggs.

4-5. (canceled)

6. The method of claim 1, wherein the yolk reaches a temperature between 60° C. to 74.0° C.

7. The method of claim 1, further comprising cooling the soft-cooked eggs to a temperature below 65° C.

8. The method of claim 1, further comprising coating the soft-cooked eggs with a protective food-grade material.

9. The method of claim 8, wherein the protective food-grade material comprises Baker's glaze, food-grade wax, white mineral oil, antimicrobial coatings, chitin-based coatings, or a combination thereof.

10. (canceled)

11. The method of claim 1, wherein the soft-cooked eggs have a shelf-life of greater than or equal to 60 days.

12. The method of claim 1, wherein the eggs are fresh eggs, nest run eggs, graded eggs, sized eggs, in-shell eggs, peeled eggs, aged eggs, tempered eggs, or a combination thereof.

13. The method of claim 1, wherein the soft-cooked eggs comprise an egg white having a tender texture and/or a yolk having a runny, pasty, or creamy texture.

14. (canceled)

15. A soft-cooked egg produced according to the method of claim 1.

16. A food product comprising the soft-cooked egg of claim 1.

17. A method of bulk-producing soft-cooked eggs, the method comprising:
(a) mechanically conveying a plurality of eggs into a steam chamber;
(b) incubating the plurality of eggs in the steam chamber;
(c) mechanically conveying the plurality of eggs into a cook bath comprising a heated liquid;
(d) incubating the plurality of eggs in the heated liquid;
(e) cooling the plurality of eggs to a first temperature;
(f) coating the plurality of eggs with a protective material; and
(g) cooling the plurality of eggs to a second temperature,
wherein the method produces a plurality of soft-cooked eggs.

18. The method of claim 17, wherein one or more of step (a)-(g) are automated.

19. The method of claim 17, wherein the steam in the steam chamber is maintained at 70° C. to 90° C. and/or wherein the heated liquid is maintained at 70° C. to 90° C.

20-21. (canceled)

22. The method of claim 17, wherein the plurality of eggs are incubated inside the steam chamber for 1 minute to 20 minutes and/or wherein the plurality of eggs are incubated in the heated liquid for 1 minute to 20 minutes.

23-24. (canceled)

25. The method of claim 17, wherein the first temperature is less than or equal to 65° C., and/or wherein the second temperature is less than or equal to 25° C.

26. (canceled)

27. The method of claim 17, wherein each egg is mechanically deposited into an egg allocator prior to step (a), and/or wherein each egg is secured in the egg allocator after being deposited into the egg allocator.

28-33. (canceled)

34. The method of claim 17, wherein the plurality of soft-cooked eggs comprises 2000-8000 soft-cooked eggs per hour.

35-36. (canceled)

37. An in-shell soft-cooked egg comprising a cooked egg white having a tender texture and/or a cooked yolk having a runny, pasty, or creamy texture, the cooked egg yolk comprising 35-150 mg of non-denatured IgY.
